(19) United States
(12) Patent Application Publication
(10) Pub. No.: US 2012/0062413 A1
(43) Pub. Date: Mar. 15, 2012

(54) Method for Correcting Position Estimations by Selecting Pseudo-Distance Measurements

(75) Inventors: Mathias VAN DEN BOSSCHE, Goyrans (FR); Mickael DALL ORSO, Neuilly-sur-Seine (FR)

(73) Assignee: THALES, Neuilly-sur-Seine (FR)

(21) Appl. No.: 13/229,733

(22) Filed: Sep. 11, 2011

(30) Foreign Application Priority Data
Sep. 10, 2010 (FR) 10 03630

(51) Int. Cl. G01S 19/40

(52) U.S. Cl. 342/357.23

(57) ABSTRACT

A method for correcting position estimations is provided, an enhanced position X_{huber} being determined by application of a robust estimation algorithm using N measurements of pseudo-distances ρᵢ corresponding to the distance measured between a navigation receiver and N satellites and an estimation Xₚᵣᵢₘ of the position of said receiver made by said receiver. The method comprises: determining normed residue values Δrⁱ_{huber} from the residues Δρⁱ_{huber} of pseudo-distances from the measurements ρᵢ, determining Σ subsets, a subset comprising N-k normed residue values Δrⁱ_{huber}, k being an integer strictly greater than 1, selecting the subset SEO with the smallest standard deviation σ^{SEO}, selecting non-aberrant measurements, a measurement being selected if the difference between the normed residues Δrⁱ_{huber} and the mean μ_{SGO} of the normed residues of the subset SEO is less than a predetermined threshold value T₁, and determining a corrected estimation X_{cln} of the position from the selected measurements.

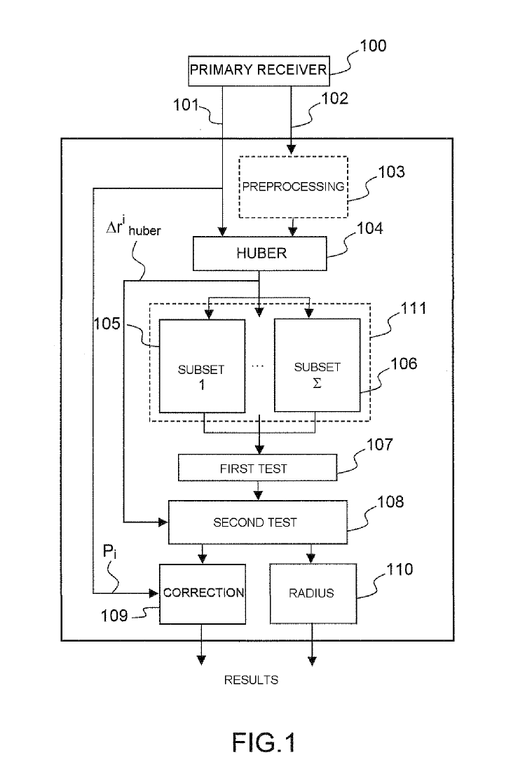

### CROSS-REFERENCE TO RELATED APPLICATION

This application claims priority to foreign French patent application No. FR 1003630, filed on Sep. 10, 2010, the disclosure of which is incorporated by reference in its entirety.

### FIELD OF THE INVENTION

The invention relates to a method for correcting position estimations by selecting pseudo-distance measurements and a receiver implementing the method. It applies notably to the field of satellite navigation systems.

### BACKGROUND

Satellite positioning systems are usually designated by the acronym GNSS, standing for “Global Navigation Satellite System”. This type of system makes it possible to estimate the position of a terminal using an embedded navigation receiver. This receiver performs measurements on the signals that reach it, said signals being transmitted by a plurality of satellites. These measurements correspond, for example, to pseudo-distances, that is to say, measurements of the distance between the satellite at the instant of transmission of the signal and the receiver at the instant of reception of the signal.

The position estimated by the navigation receiver is not always exact. In order to take account of the lack of accuracy in the positioning, it is commonplace to define a protection radius around the estimated position.

Different types of errors may degrade the accuracy of the measurements. These errors can be classified in two categories: nominal errors and non-nominal errors.

Nominal errors are measurement errors resulting from disturbances occurring in normal operation of the system. As an example, the clock used by a transmitter embedded in a satellite has a behavior which is not totally predictable. The estimation accuracy may also be affected by the environment in the vicinity of the receiver. Other forms of nominal errors are due to the reflections of the satellite signals on the ground or on buildings in the vicinity of the receiver. Also worth mentioning are the meteorological or ionospheric phenomena that may introduce a delay into the propagation of the signals to be measured.

Non-nominal errors are the result of a system malfunction. The measurements affected by such errors are also called aberrant measurements hereinafter in the description.

In order to limit the impact of these measurement errors on the accuracy of the position estimation, means making it possible to identify such errors to eliminate them and making it possible to compute a limit on the position error according to the available measurements are usually implemented and are designated by the acronym RAIM, standing for “Receiver Autonomous Integrity Monitoring”.

The current positioning appliances that include RAIM functionalities suffer from a number of problems.

A first problem is that these appliances are fully integrated, which means that it is not possible to separately choose the appliance which acquires the navigation signal and the one which computes the position of the appliance handing the integrity functions.

A second problem is that these appliances are usually based on least squares-type algorithms. This means that these appliances are destabilized by the presence of errored measurements resulting from non-nominal errors and/or an imperfect modeling of the error regardless of the amplitude of the error affecting these measurements. The solutions thus proposed are then unreliable in the face of such errors.

Robust estimation methods such as the use of the Huber algorithm make it possible to improve the estimation accuracy in the presence of aberrant measurements, but the effect of these errors is, despite everything, not inconsiderable.

### SUMMARY OF THE INVENTION

One aim of the invention is notably to overcome the abovementioned drawbacks.

To this end, the subject of the invention is a method for correcting position estimations, an enhanced position X_{huber} being determined by application of a robust estimation algorithm using N measurements of pseudo-distances ρᵢ corresponding to the distance measured between a navigation receiver and N satellites and an estimation Xₚᵣᵢₘ of the position of said receiver made by said receiver. The method comprises at least the following steps:

determination of normed residue values Δrⁱ_{huber} from the residues Δρⁱ_{huber} of pseudo-distances from the measurements ρᵢ;

determination of Σ subsets, a subset comprising N-k normed residue values Δrⁱ_{huber}, k being an integer strictly greater than 1;

selection of the subset SEO with the smallest standard deviation σ_{SEO};

selection of non-aberrant measurements, a measurement being selected if the difference between the normed residues Δrⁱ_{huber} and the mean μ_{SGO} of the normed residues of the subset SEO is less than a predetermined threshold value T₁;

determination of a corrected estimation X_{cln} of the position from the selected measurements.

According to one aspect of the invention, the robust estimation algorithm is the Huber algorithm.

The Huber algorithm is, for example, initialized by using the position Xₚᵣᵢₘ.

In one embodiment, the residues Δρⁱ_{huber} are determined by using the following expression:

Δρⁱ_{huber}=δ(Xⁱₛₐₜ−X_{huber})

in which:

Xⁱₛₐₜ represents the position of the ith satellite, said position being for example communicated to the receiver by using a signaling channel;

δ(Xⁱₛₐₜ−X_{huber}) represents the deviation between the estimation of the difference (Xⁱₛₐₜ−X_{huber}) and the measured pseudo-distance ρᵢ.

According to an advantageous embodiment of the invention, the position X_{cln} is determined by using a least squares-type method or a robust estimation method.

The normed residues Δrⁱ_{huber} can be determined by using the following expression:

Δrⁱ_{huber}−Δρⁱ_{huber}/δᵢ

in which:

δᵢ represents the a priori variances of the measurement errors.

According to one aspect of the invention, the number Σ of subsets corresponds to the number of combinations of (N-k) measurements out of N.

Moreover, the invention provides a step for determining N residues Δrⁱ_{cln} of pseudo-distances, the following expression being used:

Δrⁱ_{cln}=δ(Xⁱₛₐₜ−X_{cln})/δᵢ

in which

δ(Xⁱₛₐₜ−X_{cln}) represents the deviation between the estimation of the difference (Xⁱₛₐₜ−X_{cln}) and the measured pseudo-distance ρᵢ.

The method includes, for example, a second step for selecting measurements ρᵢ from the measurements already selected, said measurements being selected if the following expression is satisfied:

|Δrⁱ_{cln}−Δrⁱ_{huber}|<T₂

in which T₂ is a predetermined threshold value.

In one mode q implementation, a robust position estimation X_{rob} is estimated by applying the least squares method to the measurements selected during the second selection step.

A detection radius value is determined, for example, on the basis of the measurements selected during the second selection step.

The invention also relates to a navigation receiver implementing the method described previously.

Advantageously, the method makes it possible to optimize the choice of the hardware for acquiring the navigation signal independently of the hardware performing the RAIM processing. Furthermore, the robust RAIM method makes it possible to make the position estimation reliable while improving integrity performance in terms of detection compared to a standard RAIM.

### BRIEF DESCRIPTION OF THE DRAWINGS

Other features and advantages of the invention will become apparent from the following description given as a nonlimiting illustration, and in light of the appended drawings in which: the single figure shows a simplified diagram of the method for estimating the position of a navigation receiver by selecting pseudo-distance measurements.

### DETAILED DESCRIPTION

The method is based on data transmitted by a primary receiver 100, that is to say a conventional navigation receiver not implementing said method. These data correspond on the one hand to the solution estimated 101 by the primary receiver and on the other hand to the pseudo-distance measurements 102 obtained by processing signals originating from N satellites. The solution estimated by the primary receiver corresponds to the estimated position of the receiver denoted Xₚᵣᵢₘ and to the estimated clock offset. The N measurements 102 of pseudo-distances denoted ρᵢ correspond to the distance measured between the receiver and the N satellites, i corresponding to the index of one satellite out of the N satellites on which measurements are performed.

If the measurements transmitted by the primary receiver are not preprocessed, they should be made to undergo a preprocessing, known per se, ridding them of propagation and measurement errors, as symbolized by the broken line rectangle 103.

A first processing 104 applied to the solutions 101 and measurements 102 mentioned previously aims to determine an enhanced position of the receiver by the use of a robust estimation method, that is to say a method that is effective in the presence of non-nominal errors. A robust method that can be employed in the context of the invention is the so-called Huber method. This method is explained in the article by X. W. Chang and Y. Guo entitled Huber's M-estimation in relative GPS positioning: computational aspects, Journal of Geodesy, 2005, vol. 79, no. 6-7, pp. 351-362. The principle of this method is to weight the measurements ρᵢ by a function of the residue of measurements with respect to the current computation position. This computation may be initialized by using, for example, the position Xₚᵣᵢₘ determined by the primary receiver. The result of this is an enhanced position denoted X_{huber} and a set of pseudo-distance residues. The residues are denoted Δρⁱ_{huber} and are determined, for example, by using the following expression:

Δρⁱ_{huber}=δ(Xⁱₛₐₜ−X_{huber}) (1)

in which:

Xⁱₛₐₜ represents the position of the ith satellite, said position being, for example, communicated to the receiver by using a signaling channel;

δ(Xⁱₛₐₜ−X_{huber}) represents the deviation between the estimation of the difference (Xⁱₛₐₜ−X_{huber}) and the measured pseudo-distance ρᵢ.

The enhanced position X_{huber} and the set of the pseudo-distance residues Δρⁱ_{huber} obtained in this way are then used to detect any aberrant measurements among the N measurements ρᵢ.

The detection of aberrant measurements is performed by defining, first of all, normed residues Δrⁱ_{huber}, then by forming subsets of said residues and by applying statistical tests to these subsets to determine whether a measurement is aberrant or not.

The normed residues Δrⁱ_{huber} can be determined by using the following expression:

Δrⁱ_{huber}=Δρⁱ_{huber}/δᵢ (2)

in which δᵢ represents the a priori variances of the measurement errors, an error distribution model that is based on a Gaussian law usually being used.

Subsets 105, 106 comprising N-k normed residue values Δrⁱ_{huber} are then formed 111, the parameter k corresponding to the maximum number of aberrant measurements to be safeguarded against.

The number Σ of subsets determined in this way corresponds to the number of combinations of (N-k) measurements out of N, denoted Σ=C[(N-k),N]. In other words, the Σ subsets are all the combinations comprising N-k residues.

The standard deviation of these sets is then computed. Out of these sets, a set called optimal subset and designated by the acronym SGO is determined. The SGO is the set whose standard deviation δ_{SEO} is the smallest. The mean of the normed residues belonging to the SEO is determined and denoted μ_{SGO}. The determination of the set SEO makes it possible to list the k measurements that have the greatest probability of being errored and to have a reference subset that is reputed to be reliable.

Two statistical tests are then applied 107, 108 so as to deny or confirm the aberrant character of the measurements.

A first statistical test 107 is for comparing the N deviations defined by the difference between the normed residues Δrⁱ_{huber} and the mean μ_{SGO} with a threshold value T₁. This threshold value T₁ is determined so as to guarantee objectives chosen by the designer in terms of false alarm and detection performance. This test may be formulated, for example, by using the following expression:

Δrⁱ_{huber}−μ_{SEO}<T₁ (3)

If the inequality (3) for the index i is satisfied, then the ith measurement ρᵢ is not considered to be aberrant. In this case, it is retained to recompute a position X_{cln}, called proper position. This proper position is preferably determined by using the least squares method, but another estimation method such as, for example, a robust estimation method, may be used.

A second statistical test 108 making it possible to refine the position correction is then applied. For this, a new set of N residues Δrⁱ_{cln} of normed pseudo-distances is formed. The residues of this set are defined, for example, by using the following expression:

Δrⁱ_{cln}=δ(Xⁱₛₐₜ−X_{cln)/δ}ᵢ (4)

in which δ(Xⁱₛₐₜ−X_{cln}) represents the deviation between the estimation of the difference Xⁱₛₐₜ−X_{cln} and the measured pseudo-distance ρᵢ.

The standard deviation δ_{cln} of this set is determined. The deviation between the residues Δrⁱ_{cln} and the residues Δrⁱ_{huber} is determined in order to quantify the contribution of the filtering of the measurements resulting from the first test 107 to the newly estimated position X_{cln}.

If this deviation is less than a threshold value T₂, the measurements are retained. The threshold value T₂ is chosen according to the desired false alarm and detection performance levels. In other words, this test can be summarized by using the following expression:

|Δrⁱ_{cln}−Δrⁱ_{huber}|<T₂ (5)

If the inequality (5) is satisfied, then the measurement i is deemed valid, that is to say non-aberrant, and is retained.

The measurements retained following the application of the two tests are used to determine 109 a so-called robust position X_{rob}. For this, a conventional least squares method may be used. Another type of estimation may also be used.

The estimation of the protection radii 110 can then be done by using existing methods taking into account the number of measurements retained. As an example, the radius estimation algorithms used in the context of the LS-RAIM (Least-Square RAIM) type RAIM methods and of the MHSS (Multiple Hypothesesis Separate Solutions) solution separation method type may be used.

Thus, the application of the steps described previously makes it possible to obtain a corrected position solution if an error in the input measurements p, is detected. A protection radius value is also available, which makes it possible to guarantee the position solution X_{rob}.

1. A method for correcting position estimations, an enhanced position X_{huber} being determined by application of a robust estimation algorithm using N measurements of pseudo-distances ρᵢ corresponding to the distance measured between a navigation receiver and N satellites and an estimation Xₚᵣᵢₘ of the position of said receiver made by said receiver, comprising the steps:
determination of normed residue values Δrⁱ_{huber} from the residues Δρⁱ_{huber} of pseudo-distances from the measurements ρᵢ;
determination of Σ subsets, a subset comprising N-k normed residue values Δrⁱ_{huber}, k being an integer strictly greater than 1;
selection of the subset SEO with the smallest standard deviation δ_{SEO};
selection of non-aberrant measurements, a measurement being selected if the difference between the normed residues Δrⁱ_{huber} and the mean μ_{SGO} of the normed residues of the subset SEO is less than a predetermined threshold value T₁; and
determination of a corrected estimation X_{cln} of the position from the selected measurements.

2. The method as claimed in claim 1, wherein the robust estimation algorithm is the Huber algorithm.

3. The method as claimed in claim 2, wherein the Huber algorithm is initialized by using the position Xₚᵣᵢₘ.

4. The method as claimed in claim 1, wherein the residues Δρⁱ_{huber} are determined by using the following expression:
Δρⁱ_{huber}=δ(Xⁱₛₐₜ−X_{huber})
in which:
Xⁱₛₐₜ represents the position of the ith satellite, said position being for example communicated to the receiver by using a signaling channel; and
δ(Xⁱₛₐₜ−X_{huber}) represents the deviation between the estimation of the difference (Xⁱₛₐₜ−X_{huber}) and the measured pseudo-distance ρᵢ.

5. The method as claimed in claim 1, wherein the position X_{cln} is determined by using a least squares-type method or a robust estimation method.

6. The method as claimed in claim 1, wherein the normed residues Δrⁱ_{huber} are determined by using the following expression:
Δrⁱ_{huber}=Δρⁱ_{huber}/δᵢ
in which:
δᵢ represents the a priori variances of the measurement errors.

7. The method as claimed in claim 1, wherein the number Σ of subsets corresponds to the number of combinations of (N-k) measurements out of N.

8. The method as claimed in claim 1, wherein a step for determines N residues Δrⁱ_{cln} of pseudo-distances, the following expression being used:
Δrⁱ_{cln}=δ(Xⁱₛₐₜ−X_{cln})/δᵢ
in which
δ(Xⁱₛₐₜ−X_{cln}) represents the deviation between the estimation of the difference (Xⁱₛₐₜ−X_{cln}) and the measured pseudo-distance ρᵢ.

9. The method as claimed in claim 7, wherein a second step selects measurements ρᵢ from the measurements already selected, said measurements being selected if the following expression is satisfied:

|Δrⁱ_{cln}−Δrⁱ_{huber}|<T₂
in which T₂ is a predetermined threshold value.

10. The method as claimed in claim 8, wherein a robust position estimation X_{rob} is estimated by applying the least squares method to the measurements selected during the second selection step.

11. The method as claimed in claim 9, wherein a detection radius value is determined on the basis of the measurements selected during the second selection step.

12. The method as claimed in claim 10, wherein a detection radius value is determined on the basis of the measurements selected during the second selection step.

13. A navigation receiver, wherein the method as claimed in claim 1 is implemented.
